(19) United States
(12) Patent Application Publication
(10) Pub. No.: US 2024/0289630 A1
(43) Pub. Date: Aug. 29, 2024

(54) REINFORCEMENT LEARNING METHOD AND MOTOR CONTROL UNIT

(71) Applicant: TOYOTA JIDOSHA KABUSHIKI KAISHA, Toyota-shi (JP)

(72) Inventors: Akihiro KATAYAMA, Toyota-shi (JP); Shiro YANO, Tokyo (JP); Kenichiro KUMADA, Nagakute-shi (JP)

(21) Appl. No.: 18/419,555

(22) Filed: Jan. 23, 2024

(30) Foreign Application Priority Data
Feb. 27, 2023 (JP) 2023-028374

(51) Int. Cl. G06N 3/092

(52) U.S. Cl. CPC G06N 3/092

(57) ABSTRACT

A reinforcement learning method optimizes a Q table through reinforcement learning. The reinforcement learning method includes causing a computer to repeatedly calculate a first reward based on sound pressure or acceleration in each trial, calculate a second reward such that a return decreases as a time until starting of an engine is completed increases, and update the Q table such that an action is selected with which a return that is the sum of the rewards in the trials becomes larger.

### BACKGROUND

### 1. Field

The present disclosure relates to a reinforcement learning method of optimizing a Q table for selecting a torque command value to a motor for cranking an engine, and to a motor control unit equipped with a pre-trained Q table.

### 2. Description of Related Art

Japanese Laid-Open Patent Publication No. 2018-014838 discloses a machine learning device that learns a current command value of a motor. The machine learning device acquires a state variable while driving a motor in a learning process. Then, the machine learning device calculates a reward based on the state variable. The machine learning device learns the current command value based on the reward.

When an engine is started, a crankshaft of the engine is driven by the motor to perform cranking. When the motor for cranking is controlled, it is necessary to control the motor so that the engine can be started quickly.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A first aspect of the present disclosure provides a reinforcement learning method. The reinforcement learning method optimizes a Q table through reinforcement learning in which a computer is caused to repeatedly execute a trial of cranking an engine to start the engine by controlling a motor using the Q table. The Q table is used in a motor control unit that determines a torque command value for the motor by selecting an action that maximizes a Q value. The Q table defines a correspondence relationship between a state variable that includes an engine rotation speed and the most recent torque command value to the motor, the action, and the Q value.

The reinforcement learning method includes causing the computer to repeatedly, in each trial, calculate a first reward as a reward based on a sound pressure detected by a noise meter that detects noise emitted from a vehicle or an acceleration detected by an acceleration sensor that detects vibration of the vehicle, calculate a second reward as the reward such that a return decreases as a time from start of cranking to completion of starting of the engine increase, and update the Q table such that the action is selected with which the return that is the sum of the rewards in the trials becomes larger.

A second aspect of the present disclosure provides a motor control unit. The motor control unit includes processing circuitry and a storage. The storage stores a pre-trained Q table updated by the reinforcement learning method according to the first aspect. In the motor control unit, the processing circuitry is configured to refer to the pre-trained Q table stored in the storage to determine the torque command value by selecting the action that maximizes the Q value based on a state variable including an engine rotation speed and the most recent torque command value for the motor. The processing circuitry is configured to cause the motor to crank the engine by driving the motor based on the determined torque command value.

The above-described motor control unit can quickly start the engine while suppressing vibration and/or noise.

Other features and aspects will be apparent from the following detailed description, the drawings, and the claims.

### BRIEF DESCRIPTION OF THE DRAWINGS

FIG. 1 is a schematic diagram showing a configuration of a learning system and a relationship between the learning system and a vehicle.

FIG. 2 is a schematic diagram showing a configuration of a power train of the vehicle.

FIG. 3 is a timing diagram of parameters when an engine is started, in which section (a) shows transition of torque of a first motor-generator, section (b) shows presence or absence of ignition, and section (c) shows transition of an engine rotation speed.

FIG. 4 is a flowchart showing the procedure of processes related to reinforcement learning.

FIG. 5 is a flowchart showing the procedure of processes through which a motor control unit operates the first motor-generator.

FIG. 6 is a timing diagram showing transition of a torque command value.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, except for operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

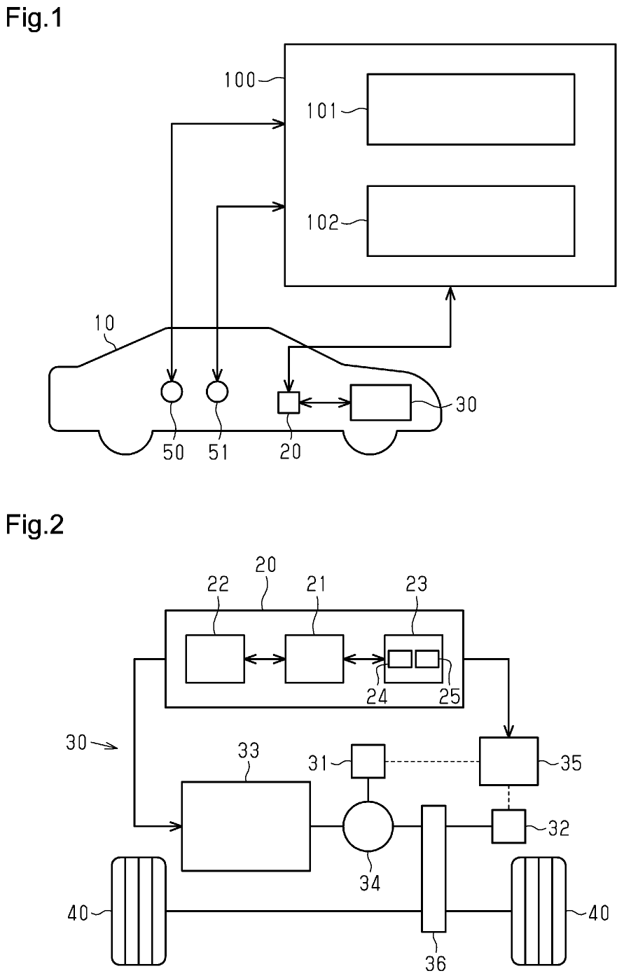

Hereinafter, an embodiment of a reinforcement learning method and a motor control unit will be described with reference to FIGS. 1 to 5.

This reinforcement learning method is a method of optimizing the Q table stored in the motor control unit 23 mounted on the vehicle 10. The reinforcement learning method is executed by a learning system 100 which is a computer that executes a program for optimizing a Q table.

### Configuration of Learning System 100

As shown in FIG. 1, the learning system 100 includes processing circuitry 101 and a storage 102. The storage 102 is a non-transitory computer readable storage medium. The storage 102 stores a program and/or data. The processing circuitry 101 executes a program stored in the storage 102. As described above, the learning system 100 optimizes the Q table stored in the storage 25 of the motor control unit 23 mounted on the vehicle 10. The motor control unit 23 is a part of the controller 20. The vehicle 10 is equipped with a hybrid system 30. The controller 20 controls the hybrid system 30.

### Configuration of Power Train of Vehicle 10

As shown in FIG. 2, the power train of the vehicle 10 includes a hybrid system 30. The vehicle 10 drives the driven wheels 40 by the hybrid system 30. The hybrid system 30 of the vehicle 10 includes a first motor generator 31, a second motor generator 32, an engine 33, a power splitting mechanism 34, a power control unit 35, and a speed reduction mechanism 36.

The second motor generator 32 is connected to the power control unit 35. The second motor generator 32 is coupled to the driven wheels 40 via the speed reduction mechanism 36. The engine 33 is coupled to the driven wheels 40 via the power splitting mechanism 34 and the speed reduction mechanism 36. The first motor generator 31 is coupled to the power splitting mechanism 34. The first motor generator 31 is, for example, a three phase AC motor generator.

The power splitting mechanism 34 is constituted by a planetary gear. The power splitting mechanism 34 can split the driving force of the engine 33 between the first motor generator 31 and the driven wheel 40. The first motor generator 31 generates electric power by the driving force of the engine 33 or by the driving force from the driven wheel 40. The first motor generator 31 drives a crankshaft of the engine 33 when the engine 33 is started. Therefore, the first motor generator 31 is a motor that drives the crankshaft of the engine 33 to crank the engine 33.

The first motor generator 31 and the second motor generator 32 are connected to a battery via a power control unit 35. The AC power generated by the first motor generator 31 is converted into DC power by the power control unit 35, and the battery is charged with the DC power. That is, the power control unit 35 functions as an inverter.

The DC power of the battery is converted into AC power by the power control unit 35 and supplied to the second motor generator 32. When the vehicle 10 is decelerated, power is generated by the second motor generator 32 using the driving force from the driven wheels 40. The battery is charged with the generated electric power. That is, regenerative charging is performed in the vehicle 10. At this time, the second motor generator 32 functions as a generator. The AC power generated by the second motor generator 32 is converted into DC power by the power control unit 35, and the battery is charged with the DC power. When the engine 33 is cranked by the first motor generator 31, the power control unit 35 converts DC power of the battery into AC power and supplies the AC power to the first motor generator 31.

### Controller 20

The controller 20 controls the engine 33, the first motor generator 31, and the second motor generator 32. The controller 20 includes an engine control unit 22 that controls the engine 33. The controller 20 includes a motor control unit 23 that controls the first motor generator 31 and the second motor generator 32 by controlling the power control unit 35. The controller 20 further includes a general control unit 21 that is connected to the engine control unit 22 and the motor control unit 23 and performs general control of the vehicle 10. Each of the control units 21 to 23 includes processing circuitry and a memory that stores a program executed by the processing circuit, i.e., a storage.

As described above, the controller 20 controls the engine 33, the first motor generator 31, and the second motor generator 32. That is, controller 20 controls the power train of vehicle 10. The controller 20 receives detection signals from sensors provided in various parts of the vehicle 10. For example, an accelerator position sensor (not shown), a brake sensor (not shown), and a vehicle speed sensor (not shown) are connected to the general control unit 21. For example, a crank position sensor (not shown), a water temperature sensor (not shown), and an air flow meter (not shown) are connected to the engine control unit 22. A crank position sensor (not shown) outputs a crank angle signal every time the crankshaft rotates by a predetermined angle. The engine control unit 22 calculates a rotation phase of the crankshaft and an engine rotation speed NE which is a rotation speed of the crankshaft based on the crank angle signal.

The motor control unit 23 receives the current, voltage and temperature of the battery via the power control unit 35. The motor control unit 23 calculates a ratio of the remaining charge amount to the charge capacity of the battery based on the current, the voltage, and the temperature.

The engine control unit 22 and the motor control unit 23 are connected to the general control unit 21 via respective communication lines. The general control unit 21, the motor control unit 23, and the engine control unit 22 mutually exchange and share information based on detection signals input from sensors and calculated information by CAN (Controller Area Network) communication.

### Cranking

As described above, the first motor generator 31 drives the crankshaft of the engine 33 to crank the engine 33. When starting the engine 33, the controller 20 drives the first motor generator 31 by the motor control unit 23 to realize cranking.

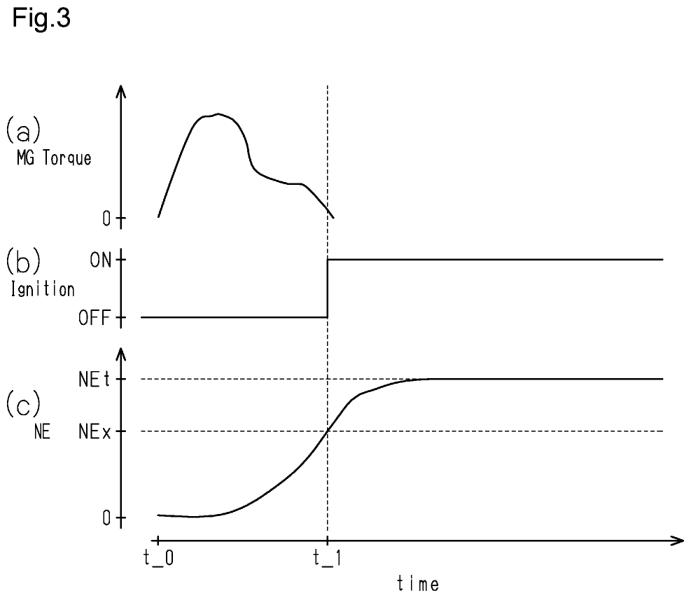

FIG. 3 shows a transition of MG (motor generator) torque when starting the engine 33, a transition of presence or absence of ignition control in the engine 33, and a transition of the engine rotation speed NE. The MG torque is a torque of the first motor generator 31. As shown in section (a) of FIG. 3, when starting of the engine 33 is started at time t_0, the motor control unit 23 increases the MG torque and starts cranking for rotating the crankshaft by the driving force of the first motor generator 31.

When the engine rotation speed NE reaches the predetermined rotation speed NEx at time t_1 as shown in section (c) of FIG. 3, the ignition control in the engine 33 is turned ON as shown in section (b) of FIG. 3, and the engine control unit 22 starts the ignition control. When the ignition control is performed in this way, the engine 33 starts self-sustaining operation. Therefore, as shown in section (a) of FIG. 3, the motor control unit 23 sets the MG torque to 0 and terminates the cranking. When the engine rotation speed NE converges to the target rotation speed NEt, the start of the engine 33 is completed.

Until the cranking is finished in this way, the motor control unit 23 controls the MG torque so that the start of the engine 33 can be quickly completed while suppressing vibration and/or noise as much as possible.

Data for cranking is stored in the storage 25 of the motor control unit 23. The storage 25 is a non-transitory computer readable storage medium. This data is a Q table that defines a correspondence relationship between a state variable that includes the engine rotation speed NE and the most recent torque command value to the first motor-generator 31, the action, and the Q value. The Q value is a value indicating a value when a certain action is taken in a certain state. The Q table stored in the storage 25 is a pre-trained Q table optimized by reinforcement learning.

The processing circuitry 24 of the motor control unit 23 refers to the Q table to determine the torque command value by selecting the action that maximizes the Q value based on the state variable including the engine rotation speed NE and the most recent torque command value for the first motor-generator 31. Specifically, in the case of this embodiment, the processing circuitry 24 selects one torque command value from among the torque command values set in six stages and determines the torque command value as the action. That is, the processing circuitry 24 refers to the Q table and selects an option having the largest Q value from among the six options based on the state variable at that time. Then, the processing circuitry 24 drives the first motor generator 31 based on the determined torque command value to cause the first motor generator 31 to crank the engine 33.

### Q-Table Optimization by Learning System 100

Next, optimization of the Q table will be described. As described above, the pre-trained Q table stored in the storage 25 of the motor control unit 23 is optimized by the reinforcement learning.

As shown in FIG. 1, the learning work for optimizing the Q table is performed in a state where the learning system 100 is connected to the vehicle 10. The learning system 100 is connected to the controller 20 of the vehicle 10. When the learning work is performed, the noise meter 50 and the acceleration sensor 51 are attached to the vehicle 10. The noise meter 50 and the acceleration sensor 51 are connected to the learning system 100. The learning system 100 connected to the controller 20 can communicate with the controller 20. Therefore, the learning system 100 can control the hybrid system 30 via the controller 20. In the learning system 100, the controller 20 can acquire various kinds of data acquired by sensors mounted on the vehicle 10.

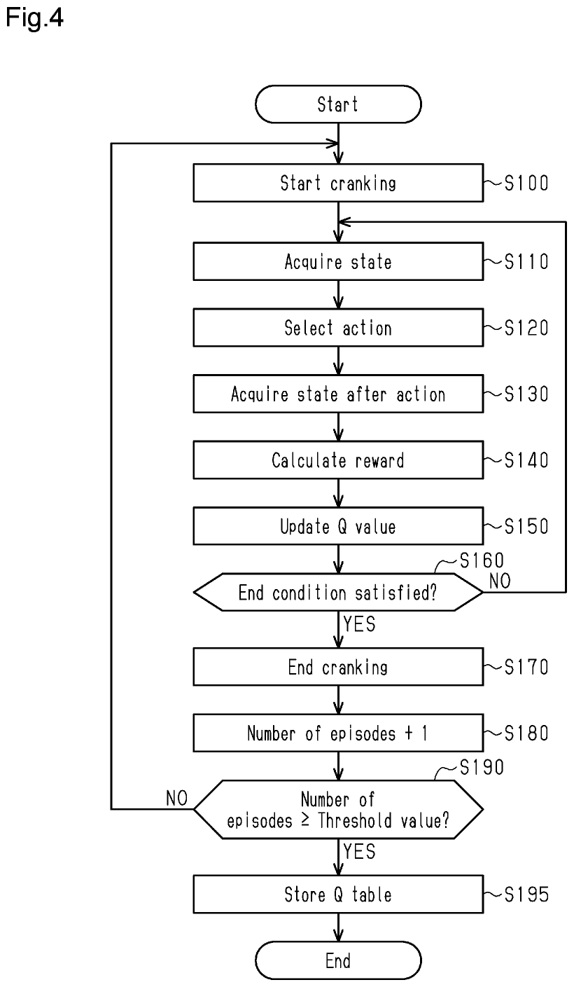

FIG. 4 is a flowchart illustrating a flow of a series of processes related to optimization of the Q table. This reinforcement learning method includes causing the learning system 100 to repeatedly execute a trial of starting the engine 33 by controlling the first motor-generator 31 using the Q table. The reinforcement learning method includes causing the learning system 100 to select an action based on the state variable with reference to the Q table in each trial. Then, the learning system 100 calculates a reward in accordance with a state after executing the selected action. As illustrated in FIG. 4, in the reinforcement learning method, the learning system 100 repeatedly acquires a state, selects an action, and calculates a reward. Thus, the learning system 100 collects data of the state before the action, the selected action, the state after the action is executed, and the reward. The learning system 100 uses the accumulated data to update the Q table so that an optimum action can be selected to achieve the final objective based on the acquired state.

The learning system 100 selects an action based on the state variable with reference to the Q table. The Q value stored in the Q table is updated as shown in the following equation.

Q(sₜ,aₜ)←Q(sₜ,aₜ)+α(rₜ₊₁+γ max Q(sₜ₊₁,a))−Q(sₜ,aₜ)

Q(s, a) is an expected value of a return obtained in the future when the action a is selected in the state s. The reward is r. The return is the sum of the rewards r up to the end of the trial. The subscript t in the state s, the action a, and the reward r in the above equation is a number indicating one step in the trial. When the state s changes after the action determination, the number t is incremented by one. In the following description, the subscript is followed by “_”. Therefore, the reward r_t+1 in the above equation is a reward obtained when the action a_t is selected in the state s_t and the state s becomes the state s_t+1. In the above equation, α is a learning rate and γ is a discount rate. The learning rate α and the discount rate γ are both larger than 0 and smaller than 1. In addition, maxQ(s_t+1, a) is the maximum value of the Q value in the previous state s_t+1 to which transition has been made by selection of the action a. The action a in this term indicates an action that maximizes Q(s_t+1, a_t+1) among actions a_t+1 that can be taken in the state s_t+1.

As described above, the action a in the learning system 100 can be selected from described above. Of course, this is merely an example, and the content of the action a need not be limited to this. The number of choices of the action a may be more or less than this.

In the reinforcement learning method of the present embodiment, the learning system 100 is caused to calculate the reward r such that the more quickly the engine 33 can be started while suppressing vibration and/or noise, the larger the return becomes. Specifically, the learning system 100 executes calculation of the first reward and calculation of the second reward as the step of calculating the reward r. The learning system 100 calculates the first reward based on the sound pressure detected by the noise meter 50. Further, the learning system 100 calculates the first reward based on the acceleration detected by the acceleration sensor 51. The learning system 100 calculates the first reward such that the return is smaller when a logical disjunction is satisfied than when the logical disjunction is not satisfied, the logical disjunction being the sound pressure being greater than or equal to a threshold value and an amount of change of the sound pressure per unit time being greater than or equal to a prescribed amount.

When the sound pressure is greater than or equal to the threshold value, the learning system 100 calculates a predetermined negative value as the reward r. For example, the learning system 100 calculates a predetermined negative value even when the amount of change in sound pressure per unit time is equal to or greater than a predetermined amount. The magnitude of these negative values may be of different magnitude. Since the learning system 100 calculates the first reward in accordance with the sound pressure in this manner, the return becomes small when the sound pressure is large and when the sound pressure changes greatly.

The learning system 100 calculates the first reward so that the return becomes smaller as the acceleration becomes larger. The acceleration sensor 51 detects acceleration in three directions of up and down, left and right, and front and rear of the vehicle 10. For example, when the acceleration in any direction exceeds a certain level, the learning system 100 calculates, as the first reward, a negative value such that the absolute value increases as the acceleration increases. Since the learning system 100 calculates the first reward in accordance with the acceleration in this manner, the return decreases as the acceleration increases. When vibration occurs, a change in acceleration caused by the vibration is detected many times until the vibration attenuates and converges. Therefore, when the first reward based on the acceleration is calculated in one trial, the calculation of the first reward based on the acceleration may be stopped thereafter. By the calculation of the first reward is stopped by adopting such a method, it is possible to avoid a situation in which the first reward is calculated many times based on the same factor and is reflected in the return.

The learning system 100 calculates a second reward such that the return decreases as a time from start of cranking to completion of starting of the engine 33 increases. For example, the learning system 100 calculates a constant negative value as the second reward each time the action a is selected and the action a of outputting the torque command value to the first motor generator 31 is executed. In other words, the learning system 100 calculates a constant negative value as the second reward every time the number t is incremented by one. Since the learning system 100 calculates the second reward in this manner, the return decreases as the time from the start of cranking to the completion of the start of the engine 33 increases.

### Flow of a Series of Processes Related to Reinforcement Learning

Next, a flow of a series of processes related to reinforcement learning will be described in detail with reference to a flowchart shown in FIG. 4.

As shown in FIG. 4, when the learning work is started, the processing circuitry 101 of the learning system 100 starts cranking in the processing of step S100. Specifically, the processing circuitry 101 sets the number t to 0 which is an initial value. Then, the processing circuitry 101 starts cranking. Immediately after the learning work is started, the number of episodes indicating the number of trials is 0.

In the process of the next step S110, the processing circuitry 101 acquires the state s. Specifically, the processing circuitry 101 acquires the engine speed NE and the most recent torque command value which are state variables. Next, the processing circuitry 101 selects the action a in the process of step S120. Specifically, the processing circuitry 101 refers to the Q table stored in the storage 102 and determines the action a from among the six options described above based on the state variable. At this time, the processing circuitry 101 selects the action a by using the ε greedy method.

In the ε greedy method, the action a having the largest Q value in the state s is selected with reference to the Q table, and the action a is randomly determined at a predetermined rate. At the beginning of learning, the action a is determined at random without substantially following the Q value. Then, as the learning progresses, that is, as the number of episodes increases, the rate at which the action a is randomly determined is gradually decreased. Finally, the action a is selected based only on the Q value.

When the processing circuitry 101 selects the action a in the process of step S120, the processing circuitry 101 outputs the torque command value according to the selected action a to control the first motor generator 31. Then, the processing circuitry 101 advances the processing to step S130.

In the process of step S130, the processing circuitry 101 acquires the state s after the action according to the action a. That is, the processing circuitry 101 acquires the state variable by performing the same processing as the processing at step S110. When the selected action a is the action a_t, the state s acquired in the processing of step S130 is the state s_t+1.

Next, the processing circuitry 101 calculates the reward r in the process of step S140. Specifically, as described above, the processing circuitry 101 executes the step of calculating the first reward and the step of calculating the second reward. When the first reward and the second reward are calculated as the reward r in this way, the processing circuitry 101 advances the processing to step S150.

In the process of step S150, the processing circuitry 101 updates the Q value stored in the Q table. The processing circuitry 101 updates the Q table by updating the Q value as shown in the above equation. The value of maxQ(s_t+1, a) needs to be calculated by inputting the state s_t+1 to the Q table. Therefore, in this embodiment, the processing circuitry 101 performs an action a plurality of times and accumulates a plurality of data in the storage 102 to create a mini-batch. Then, the processing circuitry 101 updates the Q value using the mini-batch. For example, in the reinforcement learning according to the present embodiment, the processing circuitry 101 updates the Q value every five times of selecting the action a, executing the action a, and calculating the reward r.

Next, in the process of step S160, the processing circuitry 101 determines whether or not an end condition is satisfied. The termination condition is a logical sum condition of a condition that the engine rotation speed NE becomes greater than or equal to a predetermined rotation speed NEx and a condition that an elapsed time from the start of cranking exceeds a predetermined time. The predetermined time is a threshold value for determining that the cranking is too long and the start of the engine 33 fails. For example, the predetermined time is set to several seconds.

In the process of step S160, when the processing circuitry 101 determines that the end condition is not satisfied (step S160: NO), the processing circuitry 101 returns the process to step S110. That is, the processing circuitry 101 repeats the processes from step S110 to step S150 until the end condition is satisfied, repeats the selection of the action a, the calculation of the reward r, and the update of the Q value, and continues to update the Q table.

In the process of step S160, when the processing circuitry 101 determines that the end condition is satisfied (step S160: YES), the processing circuitry 101 advances the process to step S170. In the process of step S170, the processing circuitry 101 ends the cranking. Then, in the process of the next step S180, the processing circuitry 101 increments the number of episodes by one.

Next, in the process of step S190, the processing circuitry 101 determines whether or not the number of episodes is equal to or greater than a threshold value. The threshold is a threshold for determining the completion of learning. The magnitude of the threshold is a hyperparameter determined in advance so that learning is completed when the number of episodes becomes equal to or greater than the threshold. In this embodiment, the threshold value is, for example, 1000.

In the process of step S190, when the processing circuitry 101 determines that the number of episodes is less than the threshold value (step S190: NO), the processing circuitry 101 returns the process to step S100. For example, after the engine 33 is operated for 15 seconds, the learning system 100 stops the operation of the engine 33 to end the trial. Then, the learning system 100 executes the process of step S100 after 5 seconds and starts the next trial. In a case in which the elapsed time from the start of cranking exceeds a predetermined time before the engine 33 performs self-sustained operation and cranking ends, the learning system 100 ends the trial as it is. Then, the learning system 100 executes the process of step S100 after 5 seconds and starts the next trial.

When the trial is repeated and the processing circuitry 101 determines that the number of episodes is equal to or greater than the threshold number in the process of step S190 (step S190: YES), the processing circuitry 101 causes the process to proceed to step S195. In this case, the optimization of the Q table is completed. Therefore, the processing circuitry 101 stores the pre-trained Q table in the storage 102 in the process of step S195. When the pre-trained Q table is stored in the storage 102 in this way, the processing circuitry 101 ends the series of processes related to reinforcement learning.

The data of the pre-trained Q table stored in the storage 102 of the learning system 100 in this way is stored in the storage 25 of the motor control unit 23 of the vehicle 10. As a result, the vehicle 10 can quickly start the engine 33 while suppressing vibration and/or noise.

### Flow of Processing Executed by the Motor Control Unit 23

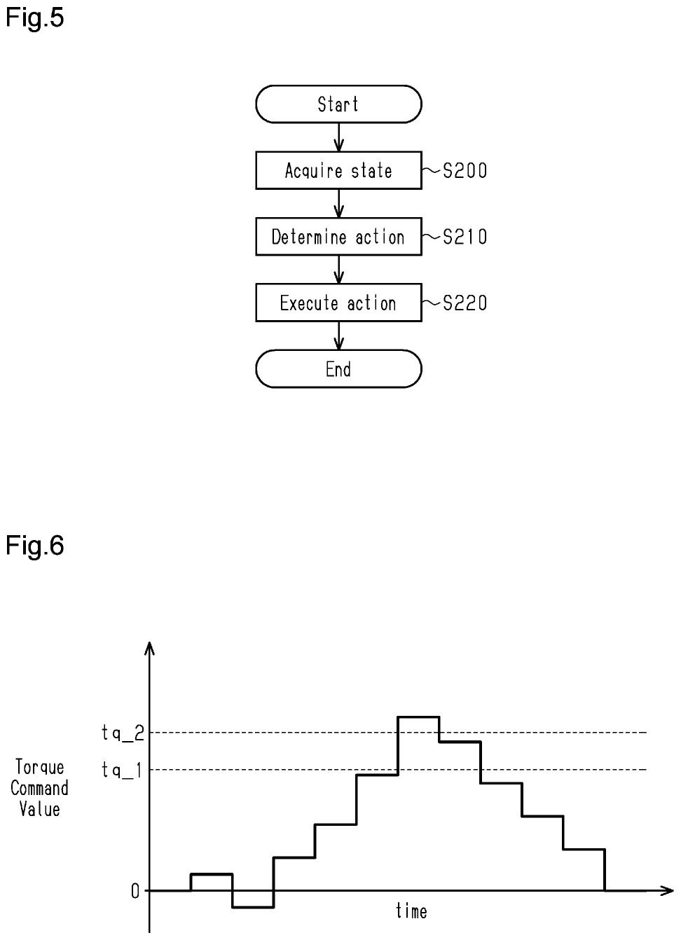

When starting the engine 33, the motor control unit 23 including the storage 25 storing the pre-trained Q table optimized by the reinforcement learning as described above performs a series of processes shown in FIG. 5 to crank the engine 33.

As shown in FIG. 5, when this series of processing is started, the processing circuitry 24 of the motor control unit 23 executes the processing of step S200. In the process of step S200, the processing circuitry 24 acquires the state s in the same manner as the process of step S110 described with reference to FIG. 4. That is, the processing circuitry 24 acquires a state variable.

Next, in the process of step S210, the processing circuitry 24 refers to the pre-trained Q table stored in the storage 25, selects the action a having the largest Q value based on the state variable, and determines the action a. When the action a is determined in this way, the processing circuitry 24 advances the processing to step S220.

In the process of the next step S220, the processing circuitry 24 executes the action a and controls the first motor generator 31 by outputting the torque command value determined based on the selected action a. Then, the processing circuitry 24 temporarily ends the series of processes.

The motor control unit 23 repeatedly executes this series of processing until the engine rotation speed NE reaches the predetermined rotation speed NEx. Thus, the motor control unit 23 repeats selecting the action a based on the state variable with reference to the pre-trained Q table and controlling the first motor generator 31. Thus, cranking of the engine 33 is performed by the motor control unit 23 using the pre-trained Q table. The motor control unit 23 determines the torque command value for the first motor generator 31 by selecting the action a that maximizes the Q value.

### Operation of Present Embodiment

In the reinforcement learning method according to this embodiment, the Q table is optimized by reinforcement learning in which an attempt to start the engine 33 is repeatedly executed. In each trial, the learning system 100 calculates the first reward based on the sound pressures and the accelerations through the step S140. In each trial, the learning system 100 that executes the reinforcement learning method calculates the second reward such that the longer the time until the start of the engine 33 is completed through the step S140, the smaller the return. Then, the learning system 100 updates the Q table such that the action a is selected with which the return becomes larger through the process of step S150.

In the reinforcement learning method described above, the second reward is calculated such that the return decreases as the time from the start of cranking to the completion of the start of the engine 33 increases. Therefore, the Q table updated by the reinforcement learning method described above is optimized such that the action a that shortens the time from the start of cranking to the completion of the start of the engine 33 is selected. Further, in the reinforcement learning method, the Q table is optimized by reflecting the information on the noise and the vibration in the calculation of the first reward.

### Advantages of Present Embodiment

(1) The above-described reinforcement learning method can optimize the Q table so that the engine 33 can be quickly started while suppressing vibration and noise.

(2) The learning system 100 calculates the first reward such that the return is smaller when the logical sum condition is satisfied than when the logical sum condition is not satisfied, the logical sum condition being that the sound pressure is equal to or greater than the threshold value and the amount of change of the sound pressure per unit time is equal to or greater than the predetermined amount.

Even if the sound pressure is less than the threshold value, when the sound pressure suddenly increases, a person tends to feel that noise has occurred. In the reinforcement learning method described above, even when the amount of change in sound pressure is equal to or greater than the predetermined amount, the first reward is calculated such that the return is smaller than that when the logical sum condition is not satisfied. Therefore, the Q table updated by the reinforcement learning method described above is optimized so that the sound pressure does not become equal to or greater than the threshold value and the sound pressure does not suddenly increase. That is, the above-described reinforcement learning method can optimize the Q table so that the engine 33 can be quickly started while suppressing noise.

(3) The learning system 100 calculates the first reward such that the return decreases as the acceleration increases. In the above-described reinforcement learning method, the Q table can be optimized so that the engine 33 can be quickly started while suppressing vibration.

(4) The motor control unit 23 includes the processing circuitry 24 and the storage 25. The pre-trained Q table updated by the reinforcement learning method is stored in the storage 25 of the motor control unit 23.

As shown in FIG. 5, the processing circuitry 24 refers to the pre-trained Q table stored in the storage 25, and determines the torque command value by selecting the action a that maximizes the Q value based on the state variables including the engine speed NE and the most recent torque command value. Then, the processing circuitry 24 drives the first motor generator 31 based on the determined torque command value to crank the engine 33.

The motor control unit 23 selects the action a using the pre-trained Q table optimized by the learning method described above. Therefore, the motor control unit 23 can quickly start the engine 33 while suppressing vibration and/or noise.

### Modifications

The present embodiment may be modified as follows. The present embodiment and the following modifications can be combined as long as the combined modifications remain technically consistent with each other.

The engine control unit 22 determines the torque command value by selecting one torque command value from the torque command values set in six stages as the action a to be selected for determining the torque command value.

However, the above-described reinforcement learning method can also be used to optimize the Q table of the motor control unit 23 that selects one from among multiple options for the amount of change of the torque command value as the action a selected to determine the torque command value.

In this case, the reinforcement learning method, for example, includes causing the learning system 100 to calculate a third reward such that the return is smaller when the torque command value exceeds a prescribed range than when the torque command value does not exceed the prescribed range. In the reinforcement learning method in this case, for example, as shown in FIG. 6, a first threshold value tq_1 and a second threshold value tq_2 are set as the threshold values of the torque command value. Then, for example, when the torque command value determined with reference to the Q table exceeds the range of 0 or more and the second threshold value tq_2 or less, the learning system 100 calculates the reward r having a negative value as the third reward. In addition, when the torque command value is greater than the first threshold value tq_1 even if the torque command value is within the range of 0 or more and the second threshold value tq_2 or less, the learning system 100 calculates, as the third reward, a negative value whose absolute value is smaller than that of the third reward calculated when the torque command value exceeds the range. The learning system 100 sets the third reward to 0 when the torque command value is within a range from 0 to the first threshold tq_1.

If the torque command value is excessively increased during cranking, the engine speed NE excessively increases immediately after the ignition control is started, resulting in an increase in fuel consumption. The first threshold value tq_1 is a torque command value serving as an upper limit for suppressing an increase in fuel consumption when starting the engine 33. The first threshold value tq_1 is a value set based on a result of an experiment performed in advance. The second threshold tq_2 is an upper limit value of the MG torque that can be realized by the first motor generator 31.

The above-described reinforcement learning method can optimize the Q table so as to prevent the torque command value from exceeding the predetermined range. Therefore, the learning system 100 can optimize the Q table so as to suppress the racing of the engine rotation speed NE that increases the fuel consumption amount. The learning system 100 can optimize the Q table so as to suppress calculation of an unrealizable torque command value. In addition, the reinforcement learning method may be a method in which the first threshold value tq_1 is not set, and the learning system 100 is caused to calculate a third reward having a negative value only in a case in which the third reward exceeds a range of 0 or more and the second threshold value tq_2 or less which is a predetermined range.

The method of calculating the first reward can be appropriately changed and employed. For example, in the reinforcement learning method, when a sound pressure equal to or greater than a threshold value is not detected, a first reward having a positive value may be calculated as the first reward. Instead of this, the reinforcement learning method may employ, as the calculation of the first reward, calculation of the first reward having a positive value when acceleration equal to or greater than a threshold value is not detected.

In the reinforcement learning method, the first reward may be calculated on the basis of only one of the sound pressure and the acceleration. That is, in the reinforcement learning method, the calculation of the first reward based on the sound pressure may be omitted. Alternatively, the reinforcement learning method may omit the calculation of the first reward based on the acceleration.

The type and number of state variables can be changed as appropriate. For example, the reinforcement learning method may increase the number of types of state variables.

In the above-described embodiment, when the first reward based on the acceleration is calculated in one trial, the calculation of the first reward based on the acceleration is stopped thereafter. On the other hand, the reinforcement learning method may be a method in which the trial is ended at a time point when the first reward based on the acceleration is calculated in one trial. In this case, when the acceleration exceeds the threshold value, a negative value having a large absolute value is calculated as the first reward, the Q value is updated, and the trial is ended.

In the above-described embodiment, the learning system 100 calculates a constant negative value as the second reward every time the learning system 100 selects the action a and executes the action a of outputting the torque command value to the first motor generator 31. On the other hand, the method of calculating the second reward so that the return becomes smaller as the time from the start of cranking to the completion of the start of the engine 33 becomes longer is not limited to this method. For example, the learning system 100 may calculate, as the second reward, a negative value having a larger absolute value as the deviation between the engine speed NE and the target engine speed NEt increases. Even with such a method, the longer the time required to complete the start of the engine 33, the smaller the return.

The measurement data of the state variables, the sound pressure, and the acceleration may not be the values themselves collected by the sensors. For example, data obtained by pre-processing data collected by a sensor may be used. Specifically, a moving average value of the values of the collected data may be calculated to remove noise included in the collected data, and the moving average value may be used. Alternatively, a maximum value or a minimum value in a certain period may be used.

In the above-described embodiment, an example of optimization of the Q calculation table used to control the first motor generator 31 when cranking the engine 33 has been described. The reinforcement learning method described above can also be applied to other motor controls. For example, the present invention can be applied to optimization of a Q table used for control of a driving motor of an electric vehicle or control of a motor for driving an electric actuator.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A reinforcement learning method of optimizing a Q table through reinforcement learning in which a computer is caused to repeatedly execute a trial of cranking an engine to start the engine by controlling a motor using the Q table, wherein
the Q table is used in a motor control unit that determines a torque command value for the motor by selecting an action that maximizes a Q value,
the Q table defines a correspondence relationship between a state variable that includes an engine rotation speed and the most recent torque command value to the motor, the action, and the Q value,
the reinforcement learning method comprises causing the computer to repeatedly, in each trial:
calculate a first reward as a reward based on a sound pressure detected by a noise meter that detects noise emitted from a vehicle or an acceleration detected by an acceleration sensor that detects vibration of the vehicle;
calculate a second reward as the reward such that a return decreases as a time from start of cranking to completion of starting of the engine increases; and
update the Q table such that the action is selected with which the return that is the sum of the rewards in the trials becomes larger.

2. The reinforcement learning method according to claim 1, wherein the computer calculates the first reward such that the return is smaller when a logical disjunction is satisfied than when the logical disjunction is not satisfied, the logical disjunction being the sound pressure being greater than or equal to a threshold value and an amount of change of the sound pressure per unit time being greater than or equal to a prescribed amount.

3. The reinforcement learning method according to claim 1, wherein the computer calculates the first reward such that the return decreases as the acceleration increases.

4. The reinforcement learning method according to claim 1, the method optimizing the Q table used in the motor control unit, wherein
the motor control unit refers to the Q table so as to select, as the action to be selected to determine the torque command value, one of multiple options for the amount of change of the torque command value, the options being set with different amounts of change, and
the reinforcement learning method further comprises causing the computer to calculate a third reward as the reward such that the return is smaller when the torque command value exceeds a prescribed range than when the torque command value does not exceed the prescribed range.

5. A motor control unit, comprising:
processing circuitry; and
a storage storing a Q table updated by a reinforcement learning method, wherein
the Q table is used in the motor control unit,
the motor control unit determines a torque command value for a motor by selecting an action that maximizes a Q value,
the Q table defines a correspondence relationship between a state variable that includes an engine rotation speed and the most recent torque command value to the motor, the action, and the Q value,
the reinforcement learning method optimizes the Q table through reinforcement learning in which a computer is caused to repeatedly execute a trial of cranking an engine to start the engine by controlling the motor using the Q table,
the reinforcement learning method includes causing the computer to repeatedly, in each trial:
calculate a first reward as a reward based on a sound pressure detected by a noise meter that detects noise emitted from a vehicle or an acceleration detected by an acceleration sensor that detects vibration of the vehicle;
calculate a second reward as the reward such that a return decreases as a time from start of cranking to completion of starting of the engine increases; and
update the Q table such that the action is selected with which the return that is the sum of the rewards in the trials becomes larger,
the processing circuitry is configured to refer to the Q table stored in the storage to determine the torque command value by selecting the action that maximizes the Q value based on a state variable including an engine rotation speed and the most recent torque command value for the motor, and
the processing circuitry is configured to cause the motor to crank the engine by driving the motor based on the determined torque command value.
